(19) United States
(12) Patent Application Publication
(10) Pub. No.: US 2025/0384428 A1
(43) Pub. Date: Dec. 18, 2025

(54) SYSTEMS AND METHODS FOR USING UNIFIED LEDGERS

(71) Applicant: JPMORGAN CHASE BANK, N.A., New York, NY (US)

(72) Inventors: Dinesh Babu PARTHASARATHI, Bournemouth (GB); Dijesh RAMAN, Tampa, FL (US); Kevin LOBO, Wimborne (GB); Paul AMOR, Blandform Forum (GB); Lawrence Charles DRAKE, Bournemouth (GB); Nicholas JOHNSTON, Poole (GB); Gopal ARUMUGAM, Bournemouth (GB)

(21) Appl. No.: 19/242,192

(22) Filed: Jun. 18, 2025

Related U.S. Application Data
(60) Provisional application No. 63/661,300, filed on Jun. 18, 2024.

(51) Int. Cl. G06Q 20/36

(52) U.S. Cl. CPC G06Q 20/367

(57) ABSTRACT

A method may include: a unified account service receiving an account creation request and creating an account with an account number; the unified account service mapping the account number to a unique identifier; the unified account service streaming the unique identifier and account data to a unified ledger; the unified ledger creating a unified ledger account that does not identify the account number for the unique identifier and setting an account balance for the unified ledger account for booking periods; a unified postings service receiving a transaction with a transaction booking period for the account; the unified postings service identifying the unique identifier for the account using the mapping; the unified postings service routing the transaction and the unique identifier to the unified ledger, and the unified ledger to updating the account balance for the unified ledger account for the booking period specified by the transaction booking period.

### RELATED APPLICATIONS

This application claims priority to, and the benefit of, U.S. Provisional Patent Application Ser. No. 63/661,300, filed Jun. 18, 2024, the disclosure of which is hereby incorporated, by reference, in its entirety.

### BACKGROUND OF THE INVENTION

### 1. Field of the Invention

Embodiments relate to systems and methods for using unified ledgers.

### 2. Description of the Related Art

Current ledgering platforms provide many more business capabilities than are necessary. For example, for a financial institution, ledgers often provide statement functionality, hold extensive reference data for downstream systems, and overhead for close of business processing. This slows down and defeats the primary functionality and benefits associated with ledgers as it not only limits the ledger's performance, but also limits scalability.

Further, different ledgers provide different capabilities and other functionality, which makes ledger applications challenging to maintain and develop.

### SUMMARY OF THE INVENTION

Systems and methods for using unified ledgers are disclosed. In one embodiment, a method may include: receiving, by a unified account service computer program, an account creation request from a system of record; creating, by the unified account service computer program, an account with an account number; mapping, by the unified account service computer program, the account number to a unique identifier and storing the mapping; streaming, by the unified account service computer program, the unique identifier and account data to a unified ledger, wherein the unified ledger is configured to create a unified ledger account on the unified ledger for the unique identifier with the account data and sets an account balance for the unified ledger account for a plurality of booking periods, wherein the unified ledger account does not identify the account number; receiving, by a unified postings service computer program, a transaction with a transaction booking period for the account; identifying, by the unified postings service computer program and using the mapping, the unique identifier for the account; and routing, by the unified postings service computer program, the transaction and the unique identifier to the unified ledger, wherein the unified ledger is configured to update the account balance for the unified ledger account for the booking period specified by the transaction booking period.

In one embodiment, the account creation request comprises an account type and account currency for the account.

In one embodiment, the method may also include receiving, by the unified account service computer program, a new account number for the account; and updating, by the unified account service computer program, the mapping to replace the account number with the new account number; wherein the unified ledger account on the unified ledger is unchanged.

In one embodiment, the method may also include receiving, by the unified account service computer program, an account type change for the account; and updating, by the unified account service computer program, the account type for the account number based on the account type change; wherein the unified ledger account on the unified ledger is unchanged.

In one embodiment, the unified ledger publishes the account balance for at least one of the booking periods to an outbox; and a consuming system is configured to receive the account balance for the unified ledger account from the outbox and to consume the account balance.

According to another embodiment, a system may include: a plurality of systems of record; a unified account service computer program; a unified postings service computer program; and a unified ledger. The unified account service computer program receives an account creation request from a system of record; the unified account service computer program creates an account with an account number; the unified account service computer program maps the account number to a unique identifier and storing the mapping; the unified account service computer program streams the unique identifier and account data to the unified ledger; the unified ledger creates a unified ledger account on the unified ledger for the unique identifier with the account data; the unified ledger sets an account balance for the unified ledger account for a plurality of booking periods, wherein the unified ledger account does not identify the account number; the unified postings service computer program receives a transaction with a transaction booking period for the account from one of the systems of record; the unified postings service computer program identifies, using the mapping, the unique identifier for the account; the unified postings service computer program routes the transaction and the unique identifier to the unified ledger; and the unified ledger updates the account balance for the unified ledger account for the booking period specified by the transaction booking period.

In one embodiment, the account creation request comprises an account type and account currency for the account.

In one embodiment, the unified account service computer program receives a new account number for the account; the unified account service computer program updates the mapping to replace the account number with the new account number; and the unified ledger account on the unified ledger is unchanged.

In one embodiment, the unified account service computer program receives an account type change for the account; the unified account service computer program updates the account type for the account number based on the account type change; and the unified ledger account on the unified ledger is unchanged.

In one embodiment, the system may also include a consuming system, and wherein the unified ledger publishes the account balance for at least one of the booking periods to an outbox, and the consuming system receive the account balance for the unified ledger account from the outbox and consumes the account balance.

According to another embodiment, a non-transitory computer readable storage medium may include instructions stored thereon, which when read and executed by one or more computer processors, cause the one or more computer processors to perform steps comprising: receiving an account creation request from a system of record; creating an account with an account number; mapping the account number to a unique identifier and storing the mapping; creating a unified ledger account on the unified ledger for the unique identifier with account data, wherein the unified ledger account does not identify the account number; setting an account balance for the unified ledger account for a plurality of booking periods; receiving a transaction with a transaction booking period for the account; identifying, using the mapping, the unique identifier for the account; routing the transaction and the unique identifier to the unified ledger; and updating the account balance for the unified ledger account for the booking period specified by the transaction booking period.

In one embodiment, the account creation request comprises an account type and account currency for the account.

In one embodiment, the non-transitory computer readable storage medium may also include instructions stored thereon, which when read and executed by the one or more computer processors, cause the one or more computer processors to perform steps comprising: receiving a new account number for the account; and updating the mapping to replace the account number with the new account number; wherein the unified ledger account on the unified ledger is unchanged.

In one embodiment, the non-transitory computer readable storage medium may also include instructions stored thereon, which when read and executed by the one or more computer processors, cause the one or more computer processors to perform steps comprising: receiving an account type change for the account; and updating the account type for the account number based on the account type change; wherein the unified ledger account on the unified ledger is unchanged.

In one embodiment, the unified ledger publishes the account balance for at least one of the booking periods to an outbox, and a consuming system is configured to receive the account balance for the unified ledger account from the outbox and to consume the account balance.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for using unified ledgers according to an embodiment;

FIG. 2 depicts a method for using unified ledgers according to an embodiment;

FIG. 3 depicts an exemplary computing system for implementing aspects of the present disclosure.

### DETAILED DESCRIPTION OF PREFERRED EMBODIMENTS

Systems and methods for using unified ledgers are disclosed.

Embodiments may decouple business functionality that is irrelevant to core ledgering capability. This may involve externalizing configurations, such as reference data, accounts, and customer data by only holding limited data elements for the ledger.

For example, a unified ledger may decouple account details from their balances, providing a flexible and efficient framework for managing accounts and transactions. This allows for seamless changes in unified account for account updates, product changes, and number modifications without disrupting existing processes, while maintaining historical movements and balances.

In embodiments, the unified ledger also provides extensive configuration options, allowing organizations to tailor account management processes to their specific needs. This flexibility supports a wide range of account types and transaction scenarios, enhancing operational efficiency and adaptability.

In embodiments, the unified ledger ensures that historical movements and balances are linked to the same account, preserving the integrity of financial data. This feature supports accurate reporting and analysis, providing valuable insights into account activity over time.

In embodiments, the unified ledger opens new possibilities for processing and maintaining multi-day balances without rolling into a particular business day. This capability enhances financial planning and decision-making, offering a comprehensive view of account balances across multiple days.

In embodiments, the unified ledger can have multiple instances serving a unified account, providing scalability and redundancy. This feature ensures that the system can handle increased load and maintain high availability, supporting business growth and continuity.

In embodiments, the unified ledger may externalize balances and posting data as made available by systems of record. The unified ledger may also make the posted data available in real time for downstream and partner systems.

In embodiments, the unified ledger may be dynamic and stateless with regard to business date processing from various payment upstream systems. For example, if a unified ledger receives a back dated posting, the ledger may process the posting as-is.

In embodiments, the unified ledger may calculate different types of business, booking, and value dated posting balances in real time.

In embodiments, the unified ledger may allow seamless processing of postings irrespective of a date flip so that processing is independent and dynamic for the account at the branch level as well for balance maintenance.

Technical advantages of unified ledgers are as follows: (1) the simplification leads to a lite weight ledger to enable higher transactions per second through enhanced design and performance; (2) they limit close of business (e.g., batch) processing to the bare minimum, thereby allowing to de-risk the platform in terms of service level agreements by making the system nearly always available (e.g., 24 hours a day, 7 days a week) and in real time; (3) they build additional headroom for future growth where capacity will increase by multifold; and (4) the simplified data structure allows the database to have repave capability within acceptable recovery time objective as the simplified ledger database is intact.

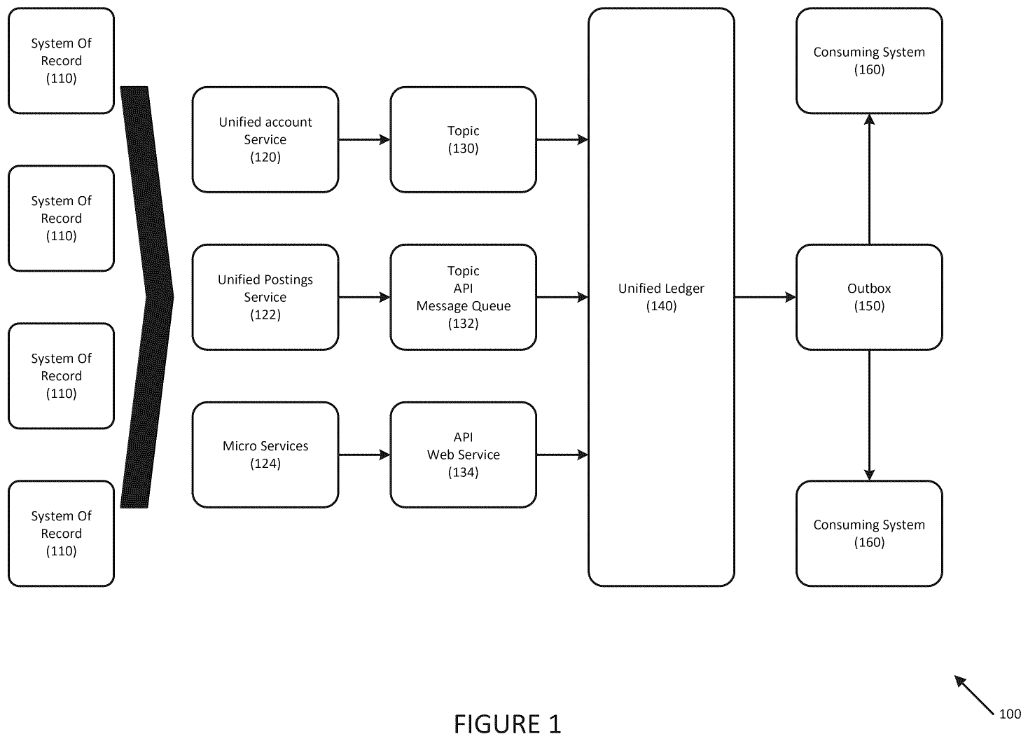

Referring to FIG. 1, a unified ledger system is disclosed according to an embodiment. System 100 may include a plurality of systems of record 110 that may provide data and transactions, such as account creation, account modification, transactions, etc. Examples of systems of record may include systems of record for accounts, account balances, etc.

System 100 may include a plurality of services (e.g., computer programs), such as unified account service 120, unified postings service 122, and microledgers service 124. Unified account service 120, unified postings service 122, and microledgers service 124 may be provided in the cloud or in non-cloud platforms.

Unified account service 120 may create, maintain, and close accounts. Unified account service 120 may also remove personal and confidential information from account data when it is written to unified ledger 140. Unified ledger 140 may still hold minimal data points that is required for operation as a ledger; however, these minimal data points may still hold some level of personal information or confidential information.

Unified account service 120 may also provide the data to topic 130, such as a KAFKA topic, which may store the data to unified ledger 140. This may be used to create or update an account with minimal personal information or confidential information. Unified account service 120 may also write contracts/attributes, and may be feature specific. In one embodiment, the contracts/attributes may contain minimal personal information or confidential information.

Unified postings service 122 may include a unified posting gateway, a unified posting core services, and may submit postings for transactions. Unified postings service 122 may post to unified ledger 140. Unified postings service 122 may provide data to topic queue, REST API, or message queue 132, which may then provide the data to the simplified ledger.

Unified postings service 122 may subscribe to topic or REST API or message queue 132 to confirmed transaction postings.

Microledgers services 124 may perform any business/product requirement, such as interest or tax calculations, sweeps based on balance, etc. Micro services 124 may submit queries to unified ledger 140 using REST calls, APIs and/or Webservices 134.

Unified ledger 140 may save the information from one or more of unified account service 120, unified postings service 122, and microledgers service 124. The data may be stored with little or no unnecessary information and may not include personal or confidential information. This reduces the overhead for unified ledger 140.

Unified ledger 140 may store account information, such as when an account is created or updated.

Unified ledger 140 may receive confirmed transaction postings, such as debits, credits, taxes, and interest. Unified ledger 140 may also receive and return balance and other queries in real-time.

Unified ledger 140 may include or be provided with outbox 150 that may interface with downstream consuming systems 160, including third-party consuming systems. For example, unified ledger 140 may stream the balance to a topic for certain use cases at the same time data Lake may also subscribe for the topic to service other use cases.

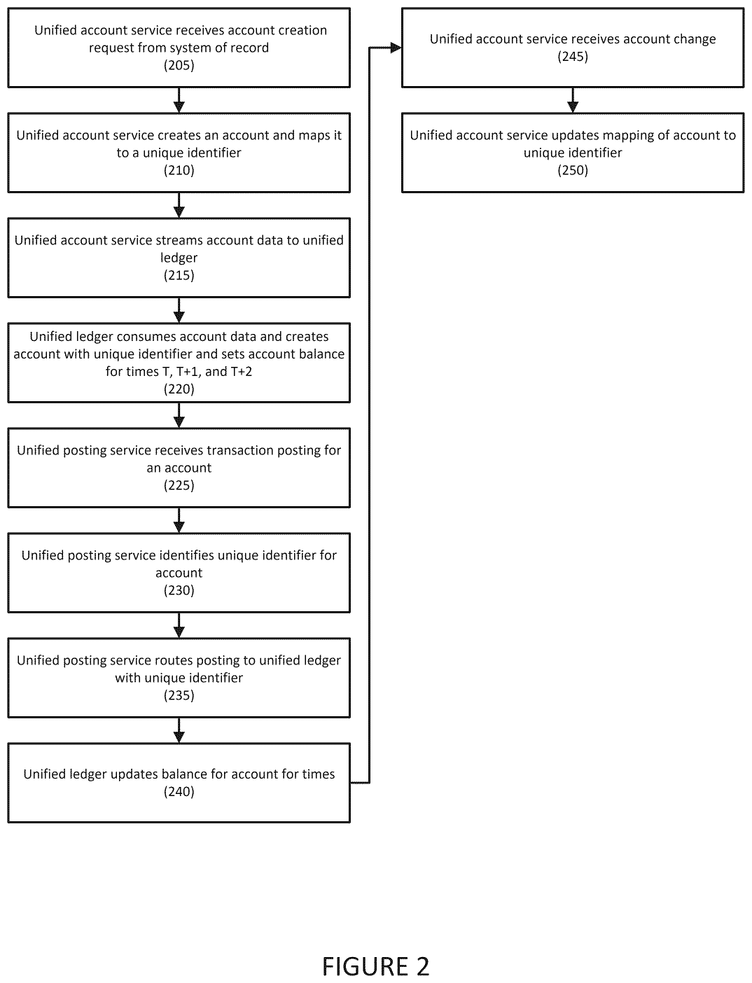

Referring to FIG. 2, a method for using unified ledgers is disclosed according to an embodiment.

In step 205, a unified account service may receive an account creation request from a system of record. The account creation request may include, for example, a type of account to be created, an account value, an account available balance, etc. Examples of account types may include personal, corporate, virtual, wallet, deposit, loan, etc.

In step 210, the unified account service may create an account with an account number. The account may be created with the account type, account owner name, etc.

The unified account service may also assign the account a unique identifier. The unified account service may map the account number to the unique identifier and store this mapping in a database.

In step 215, the unified account service may stream account data to the unified ledger. For example, the unified account service may stream the unique identifier and a currency for the account to the unified ledger. In one embodiment, the account data may be streamed using a messaging service such as KAFKA, facilitating real-time data processing.

In step 220, the unified ledger may consume account data, and may create a unified ledger account with the unique identifier on the unified ledger. The unified ledger account does not specify the account owner, account number, or account type.

The unified ledger may create the unified ledger account with a zero balance.

The unified ledger may set the account balance for the unified ledger account for a plurality of booking periods, such as time period T, T+1, T+N. For example, the unified ledger account balance may be set for Day 0 (i.e., account creation day), Day +1, and Day +N days. T, T+1, T+N represents the booking day for the transaction.

In this context, “T” represents today's business day. The unified ledger will confirm the balance for today and the next business day (T+1). It can also confirm balances for any number of future business days based on the configured number of days required for balance confirmation. Any transactions booked beyond the current projection will be warehoused and included in the projection once they fall within the projection range.

In addition, the unified ledger may maintain historical balance movements for each day, allowing for future reference or adjustments based on backdated movements.

In step 225, the unified postings service may receive a transaction posting for an account from a system of record. The transaction posting may include the booking/posting day details in the transaction.

In step 230, the unified postings service may identify the unique identifier for the account using the mapping. The unified account service may provide the mapping to the unified postings service. In one embodiment, the unified postings service may subscribe to a messaging queue, such as a KAFKA queue, to receive the mapping and any account updates.

In step 235, the unified postings service may route the transaction posting to the unified ledger with the unique identifier.

In step 240, the unified ledger may update the balance for the unified ledger account for the booking periods specified in the transaction posting. For example, a deposit posting for today (i.e., time T) results in a balance increase of $10 across T, T+1, and T+2.

An additional deposit posting of $100 updates the balance to $110 for T, T+1, and T+2.

An addition credit posting of $5 is posted with a booking date of T+1, adjusting the balance to $110 for T, $115 for T+1, and $115 for T+2.

In step 245, the unified account service may receive an account change, such as an account type change. An example of such a situation is when an account is compromised, and a new account number is assigned to the account.

In step 250, the unified account service may update the mapping of account to unique identifier with the change. The unified ledger account is unchanged.

In one embodiment, the unified ledger may stream the real time and end of day balances for the unified ledger account to a messaging queue (e.g., a KAFKA queue) via its outbox process. Any consuming systems may use the information to produce credit/debit advice, statements, risk assessment, client balance position, ledger reporting, etc.

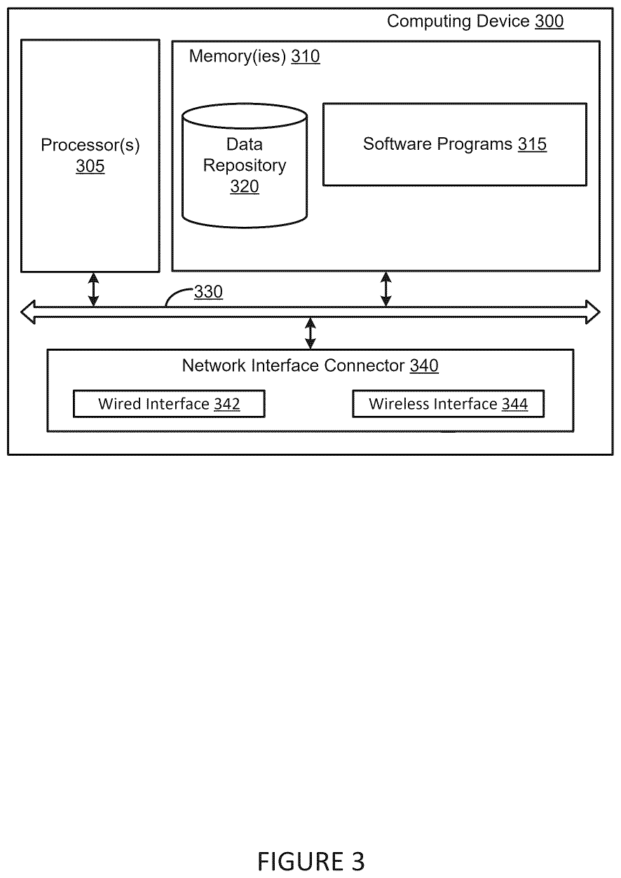

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a unified account service computer program, an account creation request from a system of record;
creating, by the unified account service computer program, an account with an account number;
mapping, by the unified account service computer program, the account number to a unique identifier and storing the mapping;
streaming, by the unified account service computer program, the unique identifier and account data to a unified ledger, wherein the unified ledger is configured to create a unified ledger account on the unified ledger for the unique identifier with the account data and sets an account balance for the unified ledger account for a plurality of booking periods, wherein the unified ledger account does not identify the account number;
receiving, by a unified postings service computer program, a transaction with a transaction booking period for the account;
identifying, by the unified postings service computer program and using the mapping, the unique identifier for the account; and
routing, by the unified postings service computer program, the transaction and the unique identifier to the unified ledger, wherein the unified ledger is configured to update the account balance for the unified ledger account for the booking period specified by the transaction booking period.

2. The method of claim 1, wherein the account creation request comprises an account type and an account currency for the account.

3. The method of claim 1, further comprising:
receiving, by the unified account service computer program, a new account number for the account; and
updating, by the unified account service computer program, the mapping to replace the account number with the new account number;
wherein the unified ledger account on the unified ledger is unchanged.

4. The method of claim 2, further comprising:
receiving, by the unified account service computer program, an account type change for the account; and
updating, by the unified account service computer program, the account type for the account number based on the account type change;
wherein the unified ledger account on the unified ledger is unchanged.

5. The method of claim 1, wherein the unified ledger publishes the account balance for at least one of the booking periods to an outbox; and
a consuming system is configured to receive the account balance for the unified ledger account from the outbox and to consume the account balance.

6. A system, comprising:
a plurality of systems of record;
a unified account service computer program;
a unified postings service computer program; and
a unified ledger;
wherein:
the unified account service computer program receives an account creation request from a system of record;
the unified account service computer program creates an account with an account number;
the unified account service computer program maps the account number to a unique identifier and storing the mapping;
the unified account service computer program streams the unique identifier and account data to the unified ledger;
the unified ledger creates a unified ledger account on the unified ledger for the unique identifier with the account data;
the unified ledger sets an account balance for the unified ledger account for a plurality of booking periods, wherein the unified ledger account does not identify the account number;
the unified postings service computer program receives a transaction with a transaction booking period for the account from one of the systems of record;
the unified postings service computer program identifies, using the mapping, the unique identifier for the account;
the unified postings service computer program routes the transaction and the unique identifier to the unified ledger; and
the unified ledger updates the account balance for the unified ledger account for the booking period specified by the transaction booking period.

7. The system of claim 6, wherein the account creation request comprises an account type and an account currency for the account.

8. The system of claim 6, wherein:
the unified account service computer program receives a new account number for the account;
the unified account service computer program updates the mapping to replace the account number with the new account number; and
the unified ledger account on the unified ledger is unchanged.

9. The system of claim 7, wherein:
the unified account service computer program receives an account type change for the account;
the unified account service computer program updates the account type for the account number based on the account type change; and
the unified ledger account on the unified ledger is unchanged.

10. The system of claim 6, further comprising a consuming system, and wherein the unified ledger publishes the account balance for at least one of the booking periods to an outbox, and the consuming system receive the account balance for the unified ledger account from the outbox and consumes the account balance.

11. A non-transitory computer readable storage medium, including instructions stored thereon, which when read and executed by one or more computer processors, cause the one or more computer processors to perform steps comprising:
receiving an account creation request from a system of record;
creating an account with an account number;
mapping the account number to a unique identifier and storing the mapping;
creating a unified ledger account on the unified ledger for the unique identifier with account data, wherein the unified ledger account does not identify the account number;
setting an account balance for the unified ledger account for a plurality of booking periods;
receiving a transaction with a transaction booking period for the account;
identifying, using the mapping, the unique identifier for the account;
routing the transaction and the unique identifier to the unified ledger; and
updating the account balance for the unified ledger account for the booking period specified by the transaction booking period.

12. The non-transitory computer readable storage medium of claim 11, wherein the account creation request comprises an account type and an account currency for the account.

13. The non-transitory computer readable storage medium of claim 11, further including instructions stored thereon, which when read and executed by the one or more computer processors, cause the one or more computer processors to perform steps comprising:
receiving a new account number for the account; and
updating the mapping to replace the account number with the new account number;
wherein the unified ledger account on the unified ledger is unchanged.

14. The non-transitory computer readable storage medium of claim 12, further including instructions stored thereon, which when read and executed by the one or more computer processors, cause the one or more computer processors to perform steps comprising:
receiving an account type change for the account; and
updating the account type for the account number based on the account type change;
wherein the unified ledger account on the unified ledger is unchanged.

15. The non-transitory computer readable storage medium of claim 11,
wherein the unified ledger publishes the account balance for at least one of the booking periods to an outbox, and a consuming system is configured to receive the account balance for the unified ledger account from the outbox and to consume the account balance.
